(19) United States
(12) Patent Application Publication
(10) Pub. No.: US 2018/0368946 A1
(43) Pub. Date: Dec. 27, 2018

(54) ORTHODONTIC SYSTEM AND METHOD OF USE

(71) Applicant: James MacLaine, Boston, MA (US)

(72) Inventor: James MacLaine, Boston, MA (US)

(21) Appl. No.: 16/014,363

(22) Filed: Jun. 21, 2018

Related U.S. Application Data
(60) Provisional application No. 62/522,810, filed on Jun. 21, 2017.

(51) Int. Cl. A61C 7/12; A61C 7/30; A61C 7/04

(52) U.S. Cl. CPC A61C 7/125; A61C 7/04; A61C 7/30

(57) ABSTRACT

An orthodontic system utilizes a plurality of ligation caps securable to tooth mounted brackets for retaining an arch wire within the respective brackets. In embodiments, the ligation cap has an outwardly extending support ridge to maintain the arch wire within an arch wire slot of the bracket. In other embodiments, the ligation cap has a substantially C-shaped cross sectional profile for frictionally engaging a pair of outwardly extending wings on the bracket. A pair of symmetrically disposed dimples midway along its length dimension to prevent inadvertent mesial-distal displacement of the ligation cap body relative to the attached bracket. A removal tool with at least one actuating part is used to remove the caps from the brackets.

### CROSS-REFERENCE TO RELATED APPLICATIONS

This application claims priority to and benefit of U.S. Provisional Application No. 62/522,810, entitled ORTHODONTIC SYSTEM AND METHOD OF USE, filed Jun. 21, 2017, which is incorporated by reference herein in its entirety and for all purposes.

### BACKGROUND

This invention relates to an orthodontic system, and, in particular to an orthodontic system with improved means for securing arch wires to orthodontic brackets.

Known orthodontic systems for straightening crooked teeth, typically referred to as “braces”, comprise a plurality of brackets for mounting onto individual teeth, typically by means of an adhesive. Each bracket typically incorporates an arch wire slot defined between pairs of wings for receiving an arch wire therein. Once the brackets have been attached to the teeth, a corrective force is applied to the brackets, and hence the teeth, by means of a shared arch wire mounted within the arch wire slot of each bracket, this force causing a reaction within the bone supporting the teeth, leading to tooth movement. The arch wire is typically retained in the arch wire slot of each bracket by a binding element known in the art as a ligature or ligation device. Ligation is the method by which the arch wire is retained in the arch wire slot of each bracket. The most commonly used type of ligature is an elastic band capable of being stretched around and fitted over the wings of the bracket and biased across the arch wire.

To accommodate a ligature, a conventional bracket has at least one pair (typically two spaced apart pairs) of oppositely extending upper and lower wings extending away from the central arch wire slot. These wings serve to retain the elastic band in an installed position, stretched around the bracket and across the arch wire slot. Accordingly, ligature installation involves stretching the elastic band so as to loop around the paired upper and lower wings of the respective bracket, stretching from top to bottom around the bracket so as to securely bias the arch wire in the arch wire slot.

Removal of a conventional ligature requires that the ligature be hooked or snagged in some manner, typically by a dental probe, and stretched back around the wings. Installation is usually accomplished by gripping the ligature with a clamping or squeezing tool at some point on its circumference and stretching the ligature around tie wings on the bracket. Unfortunately, a conventional ligature provides a minimal amount of surface to grip during installation. Therefore, conventional ligatures can be awkward to manipulate, resulting in inconvenience to the orthodontist and discomfort to a patient. Moreover, the exposed outer faces of the brackets and attached wires can cause discomfort and frequent ulceration to the patient by rubbing against the inner cheek. They also present an unsightly appearance and are prone to contamination with food particles which can lead to decay of the adjacent tooth structure.

### SUMMARY

An orthodontic system for use with a plurality of tooth mountable brackets utilizes a plurality of ligation caps adapted to be secured on a respective bracket in a snap fit manner for retaining an arch wire within the arch wire slot of the respective bracket. The system further includes a removal tool with at least one actuating part arranged to be engaged between a respective bracket and the ligation cap attached thereto to remove the cap from the bracket. In one embodiment, the ligation cap has a support ridge extending outwardly therefrom which is at least partially disposable within the arch wire slot of the bracket. In another embodiment, the ligation cap has a length dimension extending along an axis between first and second ends and a width dimension with a substantially C-shaped cross sectional profile when viewed normal to the axis for frictionally engaging a pair of outwardly extending wings on the bracket. A pair of dimples are symmetrically disposed relative to the axis midway between the first and second ends of the cap body prevent inadvertent mesial-distal displacement of the ligation cap relative to the attached bracket.

According to a first aspect of the present invention there is provided an orthodontic system comprising a plurality of brackets for mounting on individual teeth of a patient, each bracket incorporating an arch wire slot for receiving a common arch wire therein, and a plurality of ligation caps, each ligation cap being adapted to be received on a respective bracket in a snap fit manner for retaining the arch wire within the arch wire slot of the respective bracket, said ligation caps being provided on a common carrier to facilitate installation of the caps upon the brackets once the brackets have been mounted on individual teeth, a removal too being provided for removing said ligation caps from said brackets, said removal tool comprising at least one actuating part arranged to be engaged between a respective bracket and the cap attached thereto to remove the cap from the bracket.

Each ligation cap may be formed from a resilient material defining a smooth outer face.

The outer face of each ligation cap may be colored and/or has a pattern, image graphic or other graphic element applied thereto to provide a decorative or visually interesting appearance.

Each bracket may comprise a base having a lower surface adapted to be mounted on an individual tooth, said arch wire slot being defined between at least one pair of outwardly and oppositely extending wings extending from the base of the bracket, wherein each of said ligation caps is adapted to be a snap fit over the at least one pair of wings of a respective bracket, said at least one actuating part of the removal tool acting between the base of the bracket and a lower edge of the ligation cap to urge the ligation cap of the bracket when the removal tool is operated.

In one embodiment said at least one actuating part of the removal tool may comprise at least one tapered projection arranged to be inserted between the base of the respective bracket and a lower edge of the ligation cap attached thereto, said tapered projection being arranged to be urged into the gap between the base of the bracket and the lower edge of the cap such that the increasing thickness of the tapered projection away from a distal end thereof acts to push the cap off the bracket. Said actuating parts may comprise opposing tapered projections arranged to be located between the base of the respective bracket and lower edges of the ligation cap attached thereto on opposite sides of the cap, wherein said opposing tapered projections are arranged to be displaced towards one another, such that the tapered projections of the removal tool force the cap upwardly with respect to the bracket, removing the cap from the bracket. The removal force is such that no pressure is applied between the tooth and the bracket that might otherwise cause unwanted breakage of the bond between the bracket and the tooth, leading to dislodgement of the bracket from the tooth.

In an alternative embodiment said at least one actuating part of the removal tool may comprise a first part arranged to engage the base of the respective bracket and a second part arranged to engage a lower edge of the cap attached thereto, said first and second parts being arranged to be displaced away from one another, acting between the base of the bracket and said lower edge of the cap to force the cap upwardly with respect to the bracket, removing the cap from the bracket. Said actuating parts may comprise opposing parts arranged to be located adjacent opposite sides of a respective bracket, each of said opposing parts comprising a first part arranged to engage the base of the respective bracket and a second part arranged to engage a lower edge of the cap attached thereto on a respective side of the cap.

The removal tool may be arranged to retain the ligation caps once removed from the brackets. The removal tool may be adapted to retain the ligation caps within the body of the removal tool.

The removal tool may comprise a hollow body having a chamber for receiving said caps, an opening being provided at a lower end of said chamber adjacent said at least one actuating part, wherein the caps are arranged to enter the chamber via said opening when removed from the respective bracket by the action of the at least one actuating part. At least one gate or flap may be associated with said opening for retaining the caps within the chamber, said at least one gate or flap being arranged to be deflected inwardly to permit passage of a cap into the chamber. The gate or flap may be replaceable for hygiene reasons or to facilitate the removal of the caps from the chamber in the body of the tool, thus making the tool reusable.

According to a further aspect of the present invention there is provided a removal tool for removing a ligation cap from an orthodontic bracket, said removal tool comprising at least one actuating part arranged to be engaged between a respective bracket and the cap attached thereto to remove the cap from the bracket.

The at least one actuating part of the removal tool may comprise at least one tapered projection arranged to be inserted between the base of the respective bracket and a lower edge of the ligation cap attached thereto, said tapered projection being arranged to be urged into the gap between the base of the bracket and the lower edge of the cap such that the increasing thickness of the tapered projection away from a distal end thereof acts to push the cap off the bracket or may comprise a first part arranged to engage the base of the respective bracket and a second part arranged to engage a lower edge of the cap attached thereto, said first and second parts being arranged to be displaced away from one another, acting between the base of the bracket and said lower edge of the cap to force the cap upwardly with respect to the bracket, removing the cap from the bracket.

Alternatively, said at least one actuating part of the removal tool may comprise a first part arranged to engage the base of the respective bracket and a second part arranged to engage a lower edge of the cap attached thereto, said first and second parts being arranged to be displaced away from one another, acting between the base of the bracket and said lower edge of the cap to force the cap upwardly with respect to the bracket, removing the cap from the bracket. Said actuating parts may comprise opposing parts arranged to be located adjacent opposite sides of a respective bracket, each of said opposing parts comprising a first part arranged to engage the base of the respective bracket and a second part arranged to engage a lower edge of the cap attached thereto on a respective side of the cap.

The removal tool may be arranged to retain the ligation caps once removed from the brackets. The removal tool may be adapted to retain the ligation caps within the body of the removal tool.

The removal tool may comprise a hollow body having a chamber for receiving said caps, an opening being provided at a lower end of said chamber adjacent said at least one actuating part, wherein the caps are arranged to enter the chamber via said opening when removed from the respective bracket by the action of the at least one actuating part. Preferably at least one gate or flap is associated with said opening for retaining the caps within the chamber, said at least one gate or flap being arranged to be deflected inwardly to permit passage of a cap into the chamber. The gate or flap may be replaceable for hygiene reasons and/or to facilitate removal of the caps from the chamber.

According to a further embodiment of the present invention there is provided an orthodontic system comprising a plurality of brackets for mounting on individual teeth of a patient, each bracket incorporating an arch wire slot for receiving a common arch wire therein, and a plurality of ligation caps, each ligation cap being adapted to be received on a respective bracket in a snap fit manner for retaining the arch wire within the arch wire slot of the respective bracket, said ligation caps being provided on a common carrier to facilitate installation of the caps upon the brackets once the brackets have been mounted on individual teeth.

Said common carrier may comprise a series of runners and sprues formed integrally with the caps via an injection moulding process, the caps being retained on the carrier by said sprues, wherein the sprues are adapted such that respective sprues can be snapped to separate selected caps from the carrier once the cap has been attached to a respective bracket mounted on a tooth. The sprues and the runners of the common carrier may be arranged such that the caps are positioned in accordance with the physical positioning of the teeth within the mouth. For example, the caps of the top left teeth may be presented in the top left of the carrier. The left to right midline of the mouth may be represented by a stronger or more rigid line of runner material. This midline may delineate the upper caps from the lower caps. The center most runners may define a cross shape that schematically divides the dental arch into left, right, top and bottom. Each of the caps may vary in size depending upon its recipient bracket size. Thus the carrier may enable the clinician to quickly and systematically apply the caps to the correct brackets.

According to a further embodiment, a ligation cap apparatus for use with a tooth mountable bracket, the bracket defining a wire slot into which an arch wire may be at least partially retained, the ligation cap article comprises: a cap body defining an first surface disposable adjacent the bracket; a support ridge extending outwardly from the first surface and at least partially disposable within the wire slot of the bracket; and a retention feature extending outwardly from the first surface and engageable with bracket.

According to a further embodiment, a ligation cap article manufacture for use with a tooth mountable bracket comprises: an elongate cap body having a length dimension extending along an axis between first and second ends of the cap body, the cap body having a width dimension with a substantially C-shaped cross sectional profile when viewed normal to the axis; and a pair of opposed dimples disposed in the cap body between the first and second ends of the cap body, the pair of opposed dimples causing the width dimension of the cap body to be non-uniform between the first and second ends thereof. In embodiments, the pair of opposed dimples are disposed midway between the first and second ends of the cap body and are symmetrically disposed relative to the axis. In embodiments, the cap body frictionally engages a pair of outwardly extending wings on the bracket.

### BRIEF DESCRIPTION OF THE DRAWINGS

An orthodontic system in accordance with various embodiments of the present invention will now be described, by way of example only, with reference to the accompanying drawings, in which:

FIG. 1 is a perspective view a bracket of an orthodontic system in accordance with an embodiment of the present invention;

FIG. 2 is a perspective view of the bracket of FIG. 1 having a cap attached thereto for retaining an arch wire within an arch wire slot of the bracket;

FIG. 3 is a further perspective view of the bracket and cap of FIG. 2;

FIG. 4 is an end view of the bracket and cap of FIG. 2;

FIG. 5 is a perspective view of a cap from below;

FIG. 6 is a plan view of a cap delivery system in accordance with an embodiment of the present invention;

FIG. 7 is a schematic view of the bracket and cap of FIG. 2 illustrating the method of cap removal;

FIG. 8 is a front view of a cap removal tool in accordance with a first embodiment of the present invention;

FIG. 9 is a side view of the cap removal tool of FIG. 8;

FIG. 10 is an end view of the cap removal tool of FIG. 8;

FIG. 11 is a longitudinal sectional view of the cap removal tool of FIG. 8;

FIGS. 12 to 14 are detailed sectional views of the cap removal tool of FIG. 8 in use;

FIG. 15 is a front view of a cap removal tool in accordance with a second embodiment of the present invention;

FIG. 16 is an end view of the cap removal tool of FIG. 15;

FIG. 17 is a side view of the cap removal tool of FIG. 15;

FIG. 18 is a longitudinal sectional view of the cap removal tool of FIG. 15;

FIGS. 19 to 21 are detailed sectional views of the cap removal tool of FIG. 15 in use;

FIG. 22 is a longitudinal sectional view of a cap removal tool in accordance with a further embodiment of the present invention;

FIG. 23 is a further longitudinal sectional view of a cap removal tool of FIG. 22 at 90° to the view of FIG. 22;

FIG. 24 is a longitudinal sectional view of the cap removal tool of FIG. 22 in an operative configuration;

FIG. 25 is a further longitudinal sectional view of a cap removal tool of FIG. 22 at 90° to the view of FIG. 22 in said operative configuration;

FIG. 26A is a perspective view of the underside of a cap with a protuberant ridge;

FIG. 26B is a perspective view of the underside of a cap with a protuberant ridge having a bracket attached thereto for retaining an arch wire within a reduced area arch wire slot formed between the bracket and on top of a support ridge;

FIG. 27A is a perspective view of the underside of a cap with a support ridge that extends longitudinally in the mesial-distal direction;

FIG. 27B is a perspective view of the underside of a cap with a protuberant ridge having a bracket attached thereto for retaining an arch wire within an arch wire slot of the bracket and on top of a support ridge that extends longitudinally in the mesial-distal direction;

FIG. 28A-28D are detailed sectional views of the cap removal tool of FIG. 8 in use;

FIG. 29A is a perspective view of the underside of a cap with an inward concave dimple; and

FIGS. 29B-29C are perspective views of the underside of a cap with an inward concave dimple as attached to a bracket for prevention of inadvertent mesial-distal displacement of the cap.

### DETAILED DESCRIPTION

An orthodontic system in accordance with the disclosure comprises a plurality of brackets for mounting on individual teeth, an arch wire to be received within an arch wire receiving slot of each bracket for applying a corrective force to the brackets, and hence the teeth upon which they are mounted, and a plurality of caps adapted to be snap fitted onto each bracket to act as ligatures to retain the arch wire within the arch wire slot of each bracket. Also provided is a delivery system for facilitating application of the caps to the brackets and a removal tool for removing the caps, and hence the arch wire, from the brackets when it is desired to replace the arch wire.

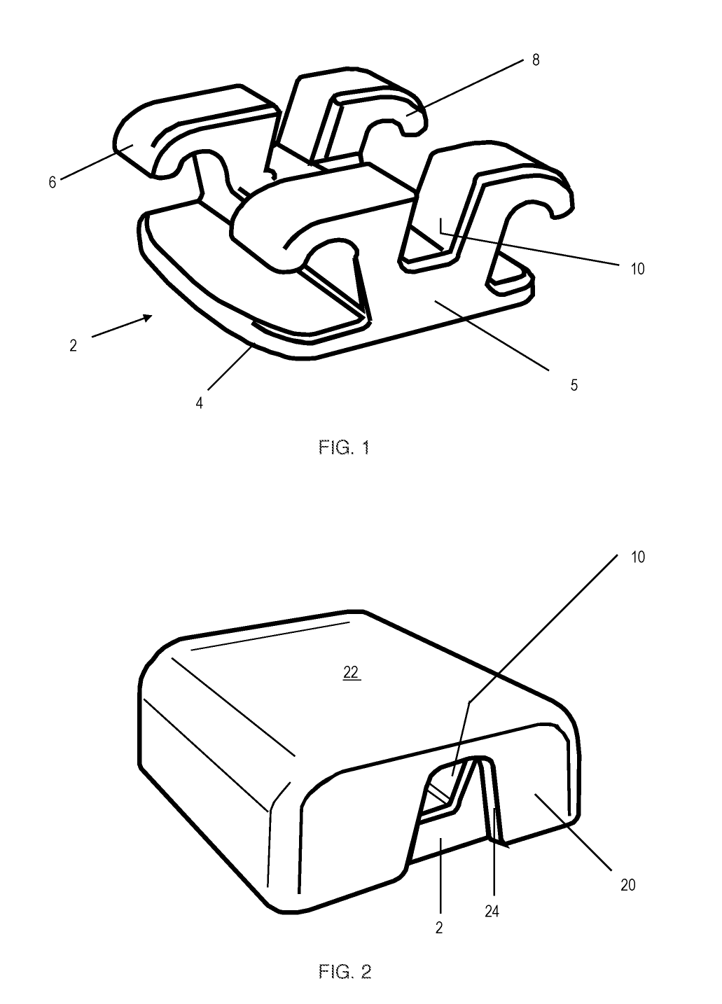

As shown in FIG. 1, each bracket 2 comprises a base 4 having a lower surface adapted to be mounted on an individual tooth by means of a suitable adhesive, as is known in the art. Each bracket 2 includes a stalk 5 extending upwardly from the base 4 and two pairs of outwardly and oppositely extending wings 6,8, said pair of wings being provided on either side of a central arch wire slot 10.

The brackets 2 may be formed from a metal, such as stainless steel or titanium, preferably by a die casting or other moulding process or a milling process. Alternatively it is envisaged that the brackets 2 may be formed from a polymeric material.

As shown in FIGS. 2 to 5, a resilient cap 20 is provided for fitment onto each bracket 2 to retain the arch wire in the arch wire slot 10 of each bracket 2 and to provide a smooth and cosmetically attractive outer finish when applied to the brackets 2 mounted on the teeth of the patient.

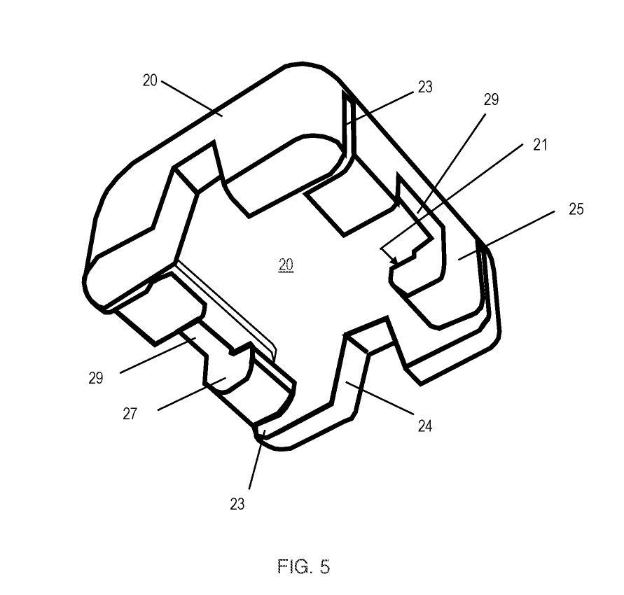

Each cap 20 may be formed from a smooth semi rigid or resilient material, such as natural or synthetic resins or polymers. In one embodiment, 20 may be formed of a material having antimicrobial properties. And is shaped to be a snap fit over the wings 6,8 of the bracket 2 while having cut-outs 24 in opposite sides of the cap 20 arranged to be aligned with the arch wire slot 10 of the bracket 2 to which the cap 20 is fitted for passage of the arch wire therethrough, such that the cap 20, when fitted to the bracket 2, securely retains the arch wire within the arch wire slot 10 of the respective bracket 2 while allowing the arch wire to slide freely within the slot 10 in a longitudinal direction with minimal friction. As best shown in FIG. 5, inwardly facing retaining teeth 21 may be provided on a lower edge of opposing sides 25,27 of the cap for engaging the undersides of the wings 6,8 of the bracket 2.

The outer face 22 of each cap 20 may be printed with any desired pattern, artwork or lettering and/or the caps 20 may be provided in a range of different colors, permitting the patient to personalize the appearance of the caps to their own taste. It is envisaged that the patient may select the pattern or image applied to each cap and/or the color of the caps prior to fitment of the system, to enable the patient to customize the caps as desired. For example, the caps may be decorated with the logo of the patient's favorite sports team or may be provided with lettering so that the patient may arrange the caps to provide a desired message or slogan when fitted to brackets attached to the patient's teeth.

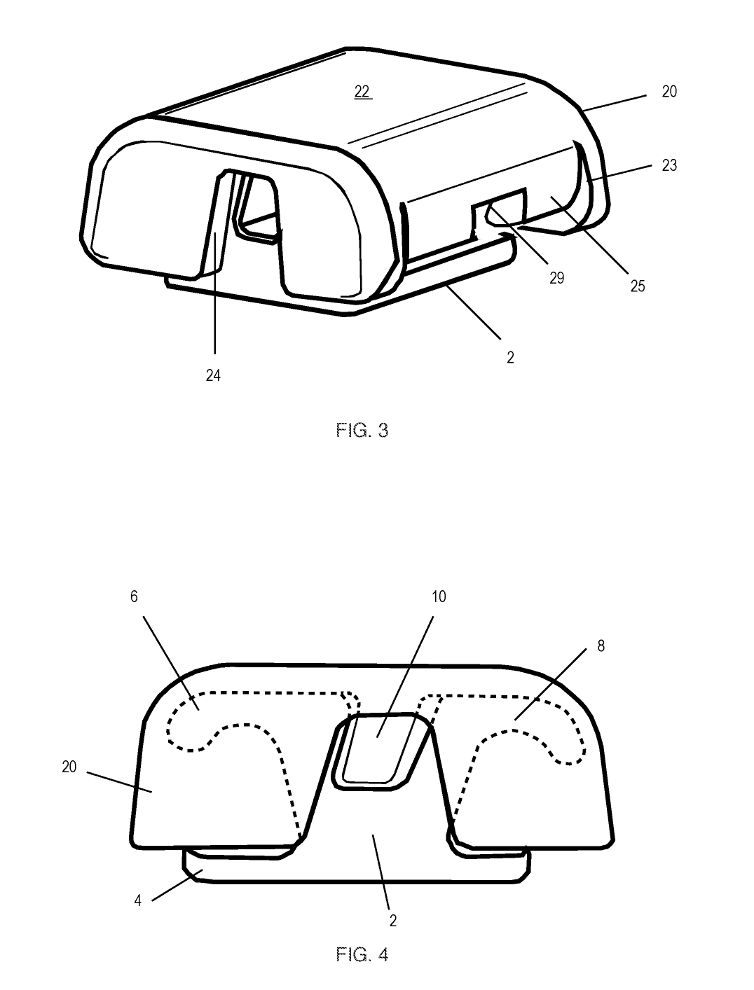

As shown in FIGS. 3 and 5, slots 23 may be formed in the opposing sides 25,27 of the cap to allow the sides 25,27 to be flexed to snap over the wings 6,8 of the bracket 2. The length of the slots 23 may be adjusted to adjust the flexibility of the sides 25,27 of the cap 20. Notches 29 may be formed in respective lower edges of the sides 25,27 of the cap 20 to facilitate insertion of a removal tool between the cap 20 and the bracket 2, as will be described below in more detail.

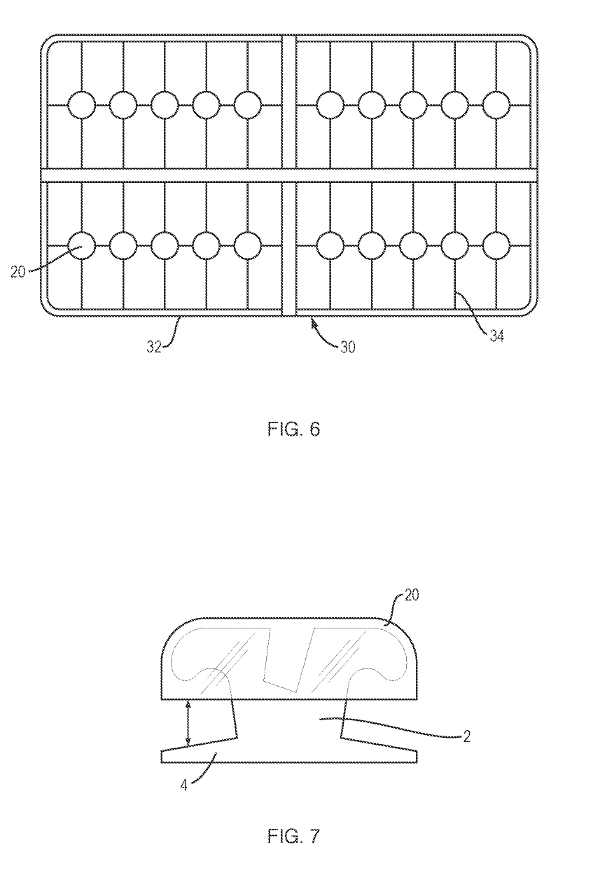

As illustrated in FIG. 6, the caps 20 may be injection moulded and provided on a common carrier 30 comprising a series of interconnected runners 32 and sprues 34, by means of which plastic is injected into the mould to form the caps 20. The sections of sprue 34 directly connected to each cap 20 may be sufficiently elastic to allow the each cap 20 to be pushed towards a respective bracket 2 when the brackets 2 have been mounted on the teeth, the sprue 34 breaking and separating the cap 20 from the carrier 30 when the cap 20 has engaged the bracket 2, facilitating the attachment of the caps 20 to the brackets 2 after placement of the arch wire 13. The sprues 34 and runners 32 of the common carrier 30 are arranged such that the caps 20 are laid out schematically on the carrier 30 to represent the physical positioning of the teeth within the mouth. The caps 20 may vary in size to suit different sized brackets applicable to different teeth within the mouth. For example, the caps of the top left teeth may be presented in the top left of the carrier. The left to right midline of the mouth may be represented by a stronger or more rigid line of runner material. This midline may delineate the upper caps from the lower caps. The center most runners may define a cross shape that schematically divides the dental arch into left, right, top and bottom. Thus the carrier may enable the clinician to quickly and systematically apply the caps to the correct brackets.

FIG. 7 illustrates schematically a cap 20 attached to a respective bracket 2. As can be seen, the open lower side of the cap 20 is dimensioned to be a snap fit over the wings 6,8 of the bracket 2 to resiliently retain the cap 20 on the bracket 2.

Removal of the cap 20 from the bracket 2 can be achieved by the application of a force acting between the upper side of the base 4 of the bracket 2 and the lower edges of the cap 20, on at least one side of the cap, more preferably on opposite sides of the cap, by the use of a suitable tool.

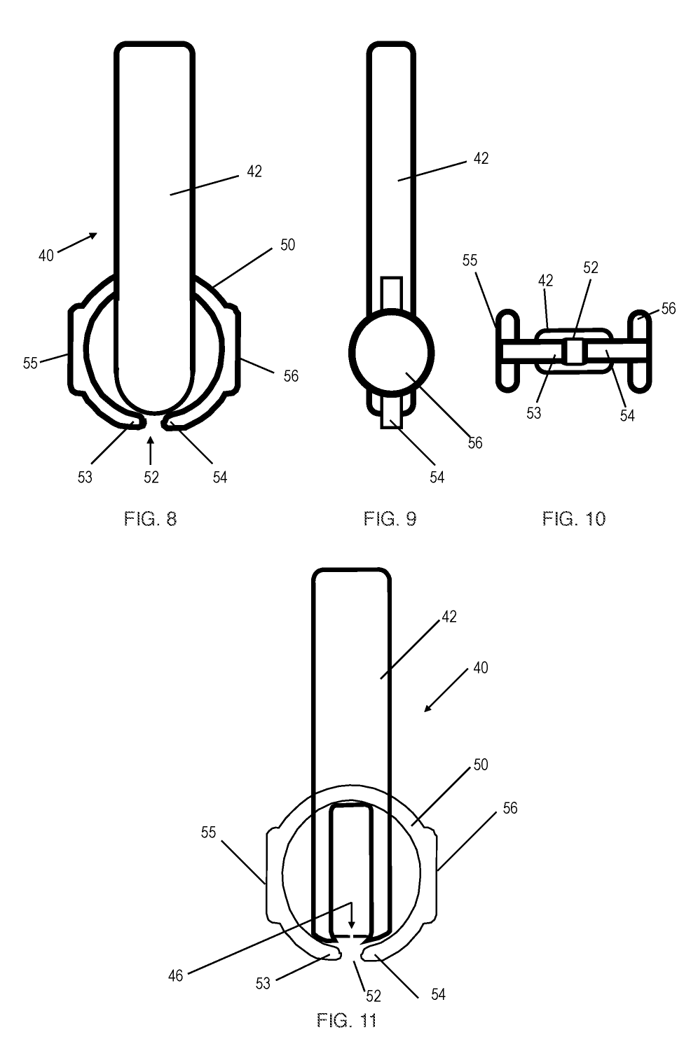

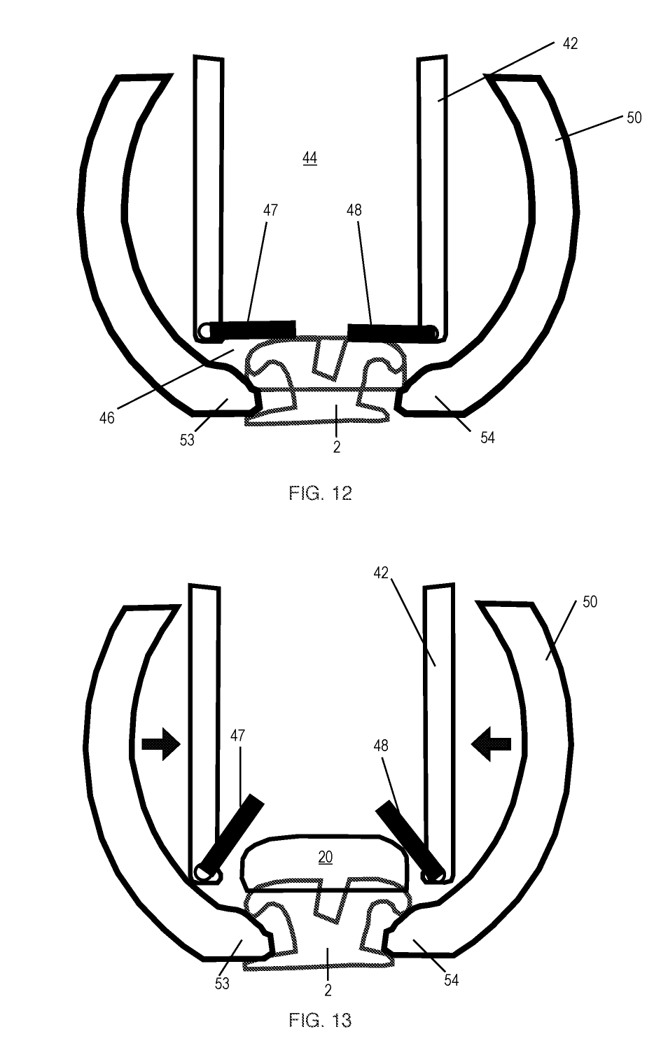

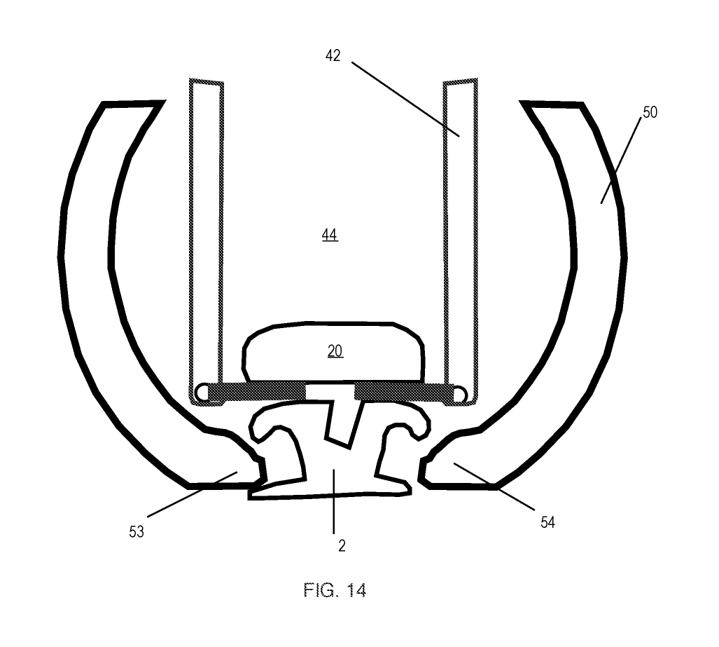

A removal tool 40 in accordance with a first embodiment of the invention is illustrated in FIGS. 8 to 14. The tool 40 comprises an elongate body 42 having a hollow chamber 44 therein communicating with an aperture 46 at a lower end of the body 42 for receiving used caps 20, as will be described below. Flaps 47,48 are provided on either side of the aperture 46, preferably attached to the sides of the aperture 46 by hinges, to allow the flaps 47,48 to be displaced from a lowered rest position, shown in FIG. 12, to a deflected position, shown in FIG. 13, the flaps 47,48 defining a one way gate into the chamber 44. The flaps 47,48 may be integrally formed with the body 42, live hinges being defined between the flaps 47,48 and the sides of the aperture 46.

A circular pincer section 50 is mounted on the body 42 of the tool 40 having an opening 52 at a lower portion thereof adjacent the aperture 46 at the lower end of the chamber 44. Terminal regions 53,54 of the pincer section 50 on either side of the opening 52 are each formed with a flat lower face and a tapered upper face, such that the vertical thickness of each terminal region 53,54 of the pincer section 50 increases away from the opening. Grip portions 55,56 are provided on either side of the pincer section 50 whereby the pincer section 50 can be squeezed to urge the terminal regions 53,54 on either side of the opening 52 towards one another.

As shown in FIGS. 12 to 14, in use, the tool 40 is located over a bracket 2 such that the terminal portions 53,54 of the pincer section 50 are located on either side of the opening 52 between the base 4 of the bracket 2 and the lower edges of the cap 20. As illustrated in FIG. 13, the grip portions 55,56 of the pincer section 50 can then be squeezed to urge the terminal portions 53,54 of the pincer section towards one another. During such movement, the tapered upper faces of the terminal portions 53,54 of the pincer section 50 engage the lower edges of the cap 20 while the flat lower faces thereof engage the base 4 of the bracket 2, forcing the cap 20 upwardly until it “pops” off the bracket 2. The force transmitted to the cap 20 to facilitate removal acts between the lower edge of the cap 20 and the base of the bracket 2. Thus, no force is applied to the bracket 2 that might dislodge or separate the bracket 2 from the tooth to which it is bonded.

As each cap 20 is removed from the respective bracket 2 by the tool 40 it passes upwardly into the hollow chamber 44 within the body 42 of the tool 40. The gate flaps 47,48 pivot open and swing upwardly to facilitate movement of the cap 20 into the chamber 44 and, thereafter, pivot downwardly to return to their closed rest position, retaining the cap 20 within chamber 44 of tool 40, thus preventing loss of the cap.

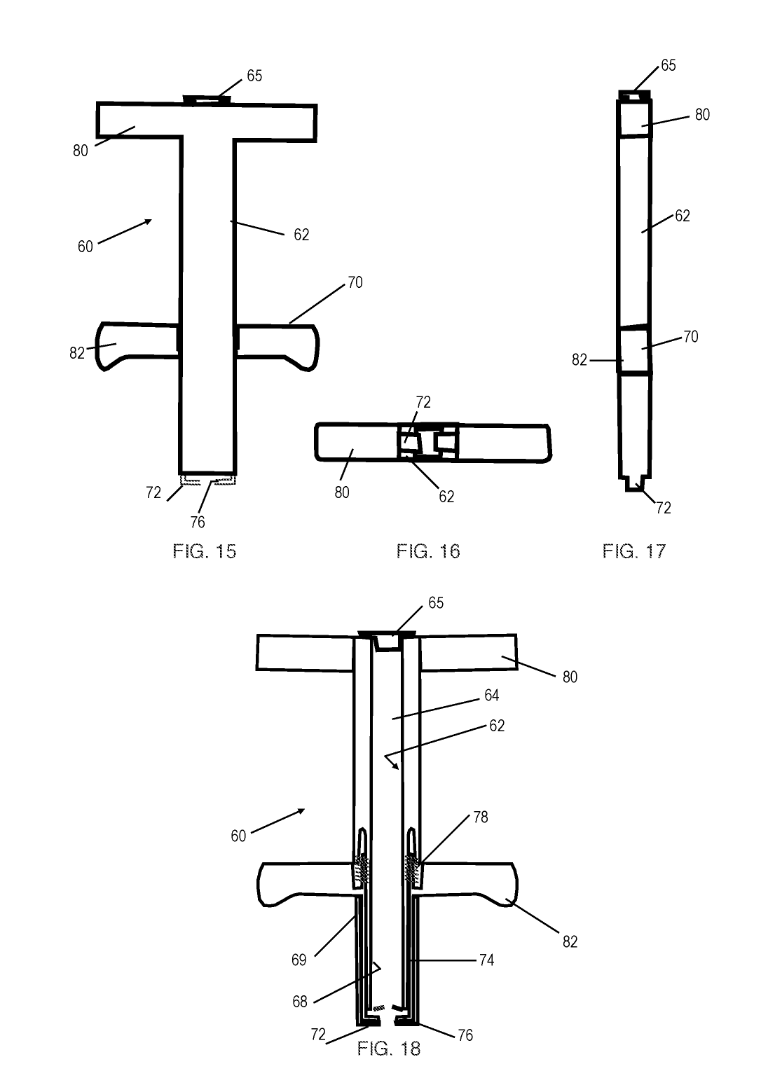

A cap removal tool 60 in accordance with a second embodiment of the present invention is illustrated in FIGS. 15 to 21.

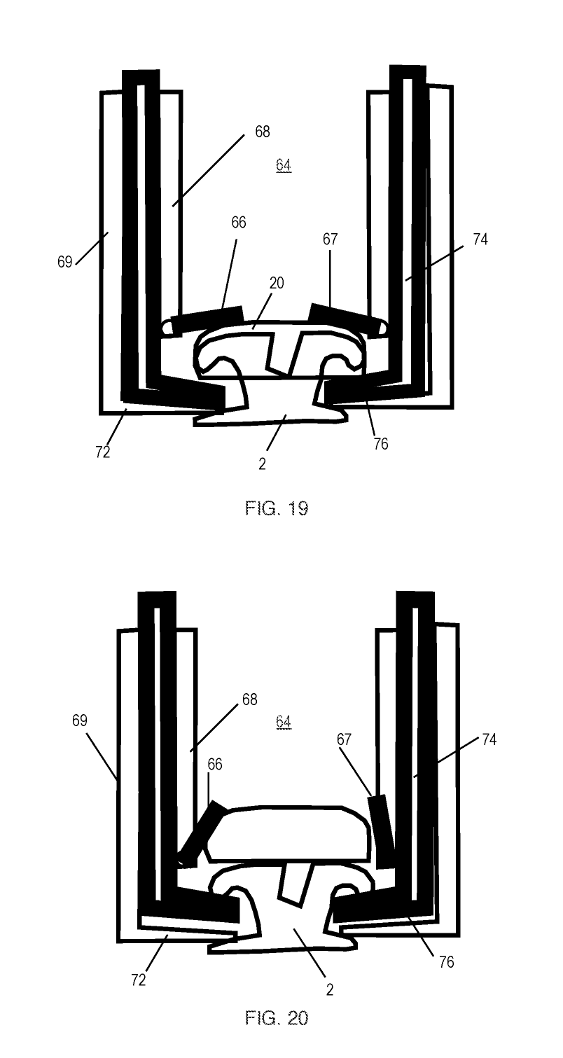

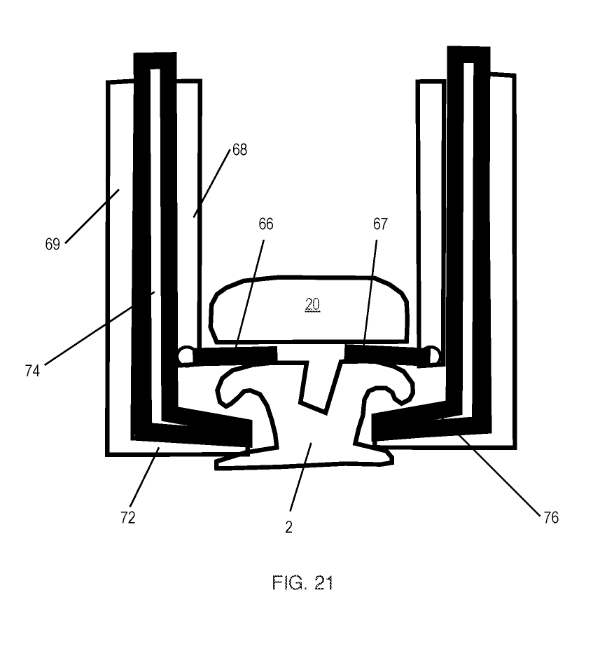

The tool 60 comprises an elongate body 62 having a hollow through bore 64 extending therethrough, defining a cap receiving chamber within the body 62 of the tool 60. A plug 65 is provided for closing an upper end of the through bore 64, said plug 65 being removable to permit removal of the collected caps from the through bore 64. Flaps 66,67 are provided at a lower end of the through bore 64, attached to the sides of the bore 64 at the lower end thereof by hinges, to allow the flaps 66,67 to be displaced from a lowered rest position, as shown in FIG. 19, to an inwardly deflected position, shown in FIG. 20, such that the flaps 66,67 define a one way gate into the lower end of the through bore 64. As with the first embodiment, the flaps 66,67 may be integrally formed with the body 62 of the tool 60, live hinges being defined between the flaps 66,67 and the sides of the bore 64.

As can be seen from FIG. 18, an annular space is defined between inner and outer walls 68,69 of the body 62 of the tool 60 in a lower section thereof, within which is slidably received an operating part 70 of the tool 60. The inner wall 68 of the body 62 of the tool 60 is shorter in length than the outer wall 69 such that the outer wall 69 extends beyond the inner wall 68 at a lower end of the body 62. The outer wall 69 terminates in an inwardly extending lip 72, as will be described below in more detail, defining a narrowed opening at a lower end of the body 62.

The operating part 70 of the tool 60 comprises a tubular body 74 having an inwardly extending lip 76 formed at a lower end thereof defining a narrowed opening at a lower end of the operating part 70 aligned with said narrowed opening of the body 62 of the tool 60.

The tubular body 74 of the operating part 70 of the tool 60 is axially slidable with the annular space between inner and outer walls 68,69 of the lower section of the body 62 of the tool 60 between an extended position, shown in FIG. 18, wherein a lower end of the operating part 70 engages the inwardly extending lip 72 at the lower end of the outer wall 69 of the body 62 of the tool 60, and a retracted position, shown in FIG. 20. The operating part 70 is biased towards its extended position by a suitable biasing means, such as a spring 78.

Aligned pairs of radially extending handles 80,82 are respectively provided on an upper region of the body 62 and extending from an upper region of the tubular body 74 of the operating part 70, the latter extending through slots or openings formed in the outer wall 69 of the body 62 of the tool 60, whereby the operator can manipulate the handles 80,82 to operate the tool in the manner of a syringe to urge the operating part 70 from its extended position to its retracted position by squeezing the handles 80,82 towards one another.

In use, the tool 60 is pushed down onto a bracket 2 such that the cap 20 is forced through the aligned narrowed openings of the body and the operating part, such parts being formed from a suitably resilient material to permit the passage of the cap through said openings, whereby the inwardly extending lips 72,76 of the body 62 and operating part 70 of the tool 60 are located between the base 4 of the respective bracket 2 and a lower edges of the cap 20. The tool 60 may also slide into its correct position relative to the cap 20 and base 4 of the respective bracket 2 from the mesial or distal sides, meaning that no strain or stress is exerted on the inward extending lips 72, 76 of the body 62 and operating part 70 of the tool.

The operating part 70 is then urged to its retracted position, causing the inwardly extending lip 76 of the operating part 70 to act against the lower edges of the cap 20 while the inwardly extending lip 72 of the body 62 of the tool 60 acts against the upper face of the base 4 of the bracket 2, causing the cap 20 to be forced off the bracket 2. Once the cap 20 has been forced off the bracket it passes into the hollow through bore 64 of the body 62, past the flaps 66,67, which are urged to their deflected position by the cap. The flaps 66,67 subsequently return to their rest position, retaining the cap 20 within the through bore 64 of the body 62 of the tool 60.

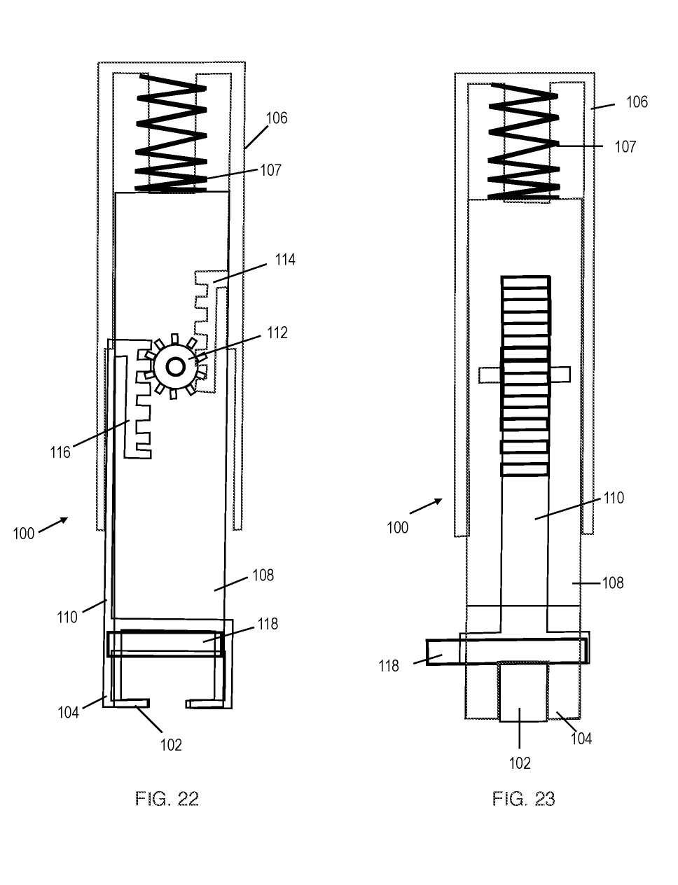

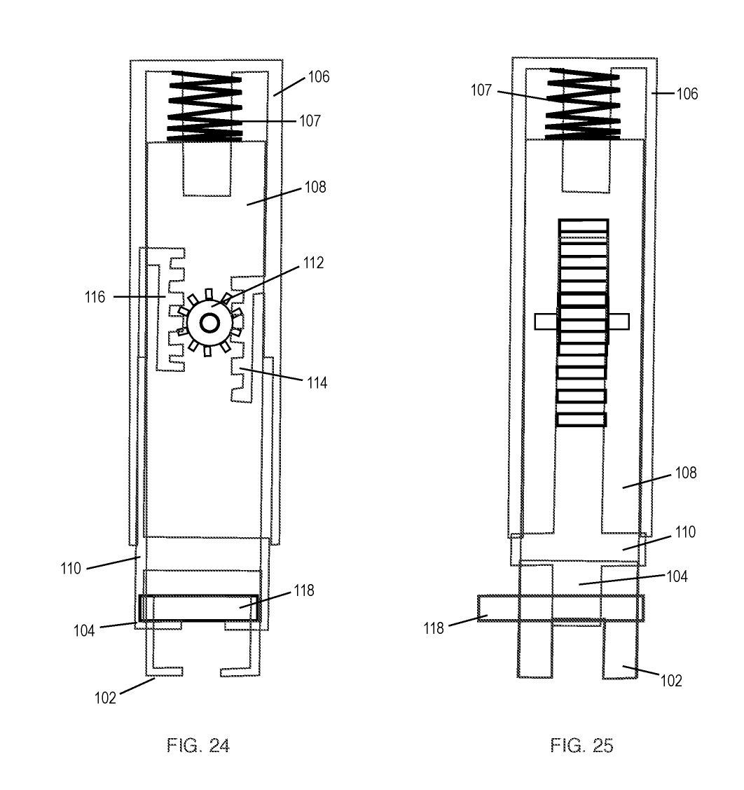

A cap removal tool in accordance with a third embodiment of the present invention is illustrated in FIGS. 22 to 25.

The cap removal tool 100 in accordance with the third embodiment is similar to that of the second embodiment in so far as it comprises a pair of opposed first operating parts 102 adapted to engage an underside of the respective cap 20 and a pair of opposed second operating parts 104 adapted to engage the base of the respective bracket 2, the first and second operating parts 102,104 being displaceable away from one another to urge the cap 20 away from the bracket 2.

In order the facilitate insertion of the operating parts 102,104 between the bracket 2 and the cap 20, the operating parts 102,104 may be laterally offset so that they can line up with one another when in a retracted position, as shown in FIGS. 22 and 23. In the embodiment shown, the first operating part 102 on each side of the tool 100 is located centrally within an opening define in each second operating part 104, such that each second operating part 104 is divided into two parts located on either side of each respective first operating part 102.

The cap removal tool 100 of the third embodiment is designed so that a downwards force on a head portion 106 of the tool 100 causes the first operating parts 102 to be displaced vertically away from the second operating parts 104 to pop the cap 20 off the bracket 2.

The tool 100 comprises a central body portion 108, the second operating parts 104 being mounted on a lower end thereof. The first operating parts 102 are mounted on a carrier part 110 slidably supported on the body portion 108 for vertical movement with respect thereto. The head portion 106 is slidably mounted over an upper end of the central body portion 108. A spring 107 is located between the head portion 106 and the body portion 108 to urge the head portion 108 away from the body portion 106.

A gear 112 is rotatably within the body portion 106, the gear engaging a first rack 114 mounted on the head portion 106 and a second rack 116 mounted on the carrier part 110, such that a downward displacement of the head portion 106 with respect to the body portion 108 causes the first rack 114 to act on the gear 112 to rotate the gear 112, whereby the gear 112 acts on the second rack to displace the carrier part 110 upwardly with respect to the body portion 108, displacing the first operating parts 102 away from the second operating parts 104 to urge the cap 20 away from the bracket 2.

As with the previous embodiments, the body portion 108 of the tool 100 may include a hollow section adjacent a lower end thereof for receiving caps 20 once removed from the brackets 2. A gate 118 is located at an entrance to the hollow section of the body portion 108, through which the caps 20 pass when removed from the brackets 2. The gate 118 may comprise opposing rows of bristles through which the cap must pass to enter the body portion 108 of the tool 100. The gate 118 may be removable and replaceable to facilitate retrieval of the caps from the body portion 108 of the tool, facilitating re-use of the tool following standard decontamination procedures.

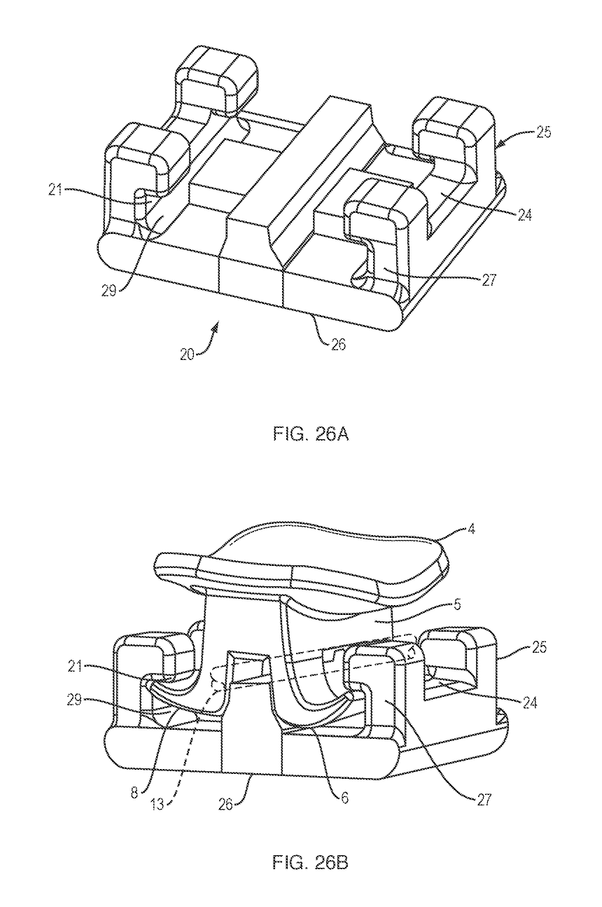

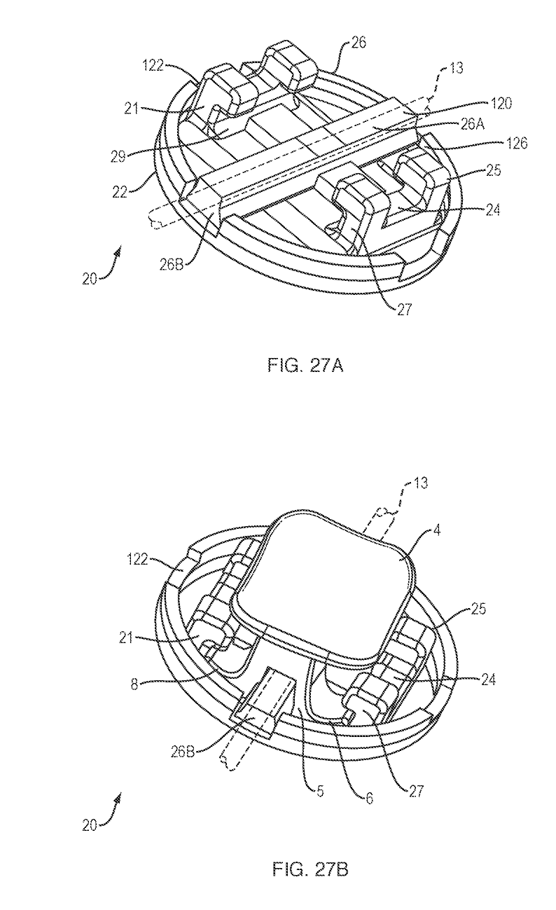

According to another aspect of the disclosure, as shown in FIG. 26A-26B, an alternative embodiment of cap 20 is illustrated in which a protuberant support ridge 26 may be formed longitudinally between opposing sides 25, 27 and opposing pairs of inwardly retaining teeth 21 of cap 20 to support and retain the arch wire in the arch wire slot 10 of each bracket 2 and to reduce the effective space of the arch wire slot 10. Ridge 26 may be shaped to compliment the sides of slot 10 so as to be at least partially received within wire slot 10. In the illustrated embodiment, the side walls of support ridge 26 are narrowed or tapered to mimic the shape of wire slot 10 as defined by bracket 4. When cap 20 is secured to bracket 4, as illustrated in FIGS. 26B and 27B, support ridge 26 is at least partially disposed within wire slot 10 thereby reducing volume and depth of the wire slot space. Compression of an undersized arch wire 13 by support ridge 26 into the arch wire slot 10 increases the arch wire deflection at sides 25, 27, allowing an increase of force to affect the tooth's 124 movement.

As shown in FIGS. 27A-27B, another alternative embodiment of the cap 20 is illustrated in which the ridge 26 of the cap 20 extends longitudinally beyond the natural mesial-distal periphery of the bracket 2 and opposing sides 25, 27 to reduce inter-bracket arch wire span which effectuates a stiffer arch wire. A stiffer arch wire may increase the force exerted on wings 4, 6 of the bracket 2. The terminal ends 26A, 26B of ridge 26 rest in an indentations 120 of a raised lip 126, which in the illustrative embodiment defines a substantially circular, peripheral outer surface 22, but may be designed in a variety of shapes, including, but not limited to, an oval, a square, and a rectangle. The outer surface 22 may include one or more optional indentations in a raised lip 126 that align with cut out 24 of the cap 20.

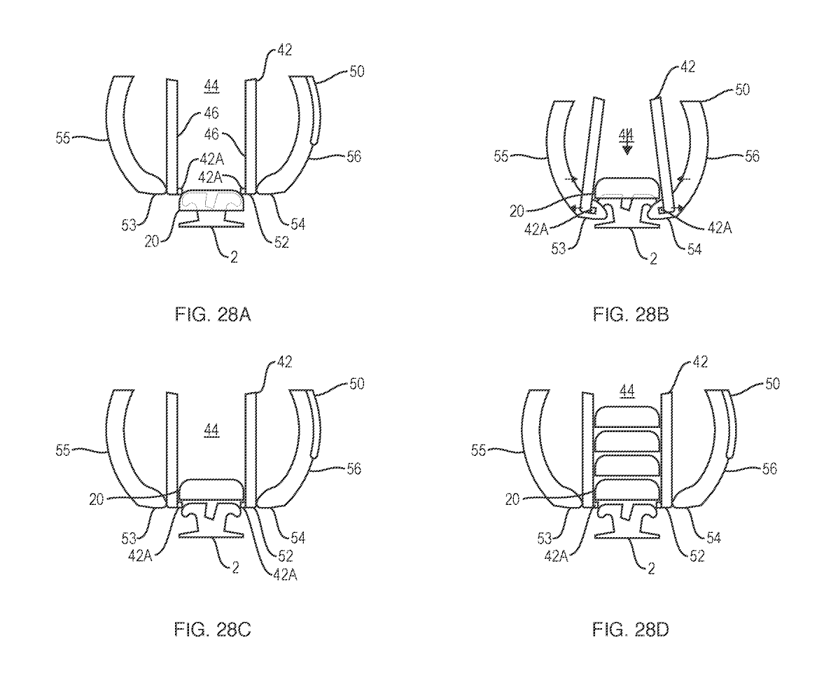

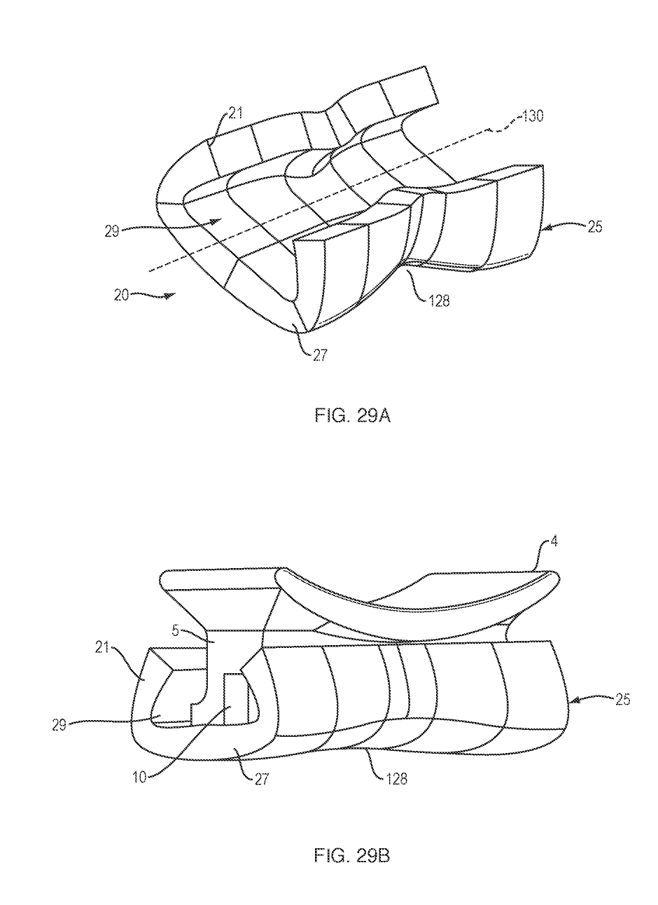

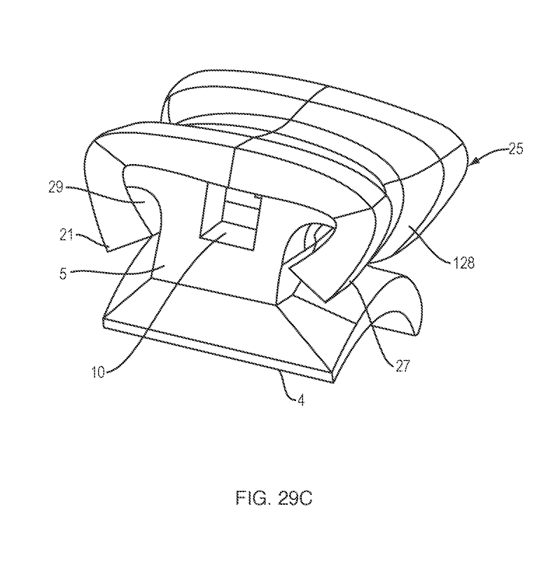

According to another aspect of the disclosure, an alternative embodiment of removal tool 40 that enables removal and collection of multiple size caps 20 from bracket 2 into the removal tool 40 is shown in FIGS. 28A-D. Tool 40 comprises an elongate body 42 having a hollow chamber 44 therein communicating with contiguously attached lips 42A at a lower end of the body 42 for receiving used caps 20, as will be described below. Lips 42A are provided on either side of the body 42 to engage the outer surface 22 of cap 20, as shown in FIG. 29A.

An arcuate pincer section 50 is mounted on the body 42 of the tool 40 having an opening 52 at a lower portion thereof adjacent the aperture 46 at the lower end of the chamber 44. Terminal regions 53,54 of the pincer section 50 on either side of the opening 52 are each formed with a tapered upper surface, such that the vertical thickness of each terminal region 53,54 of the pincer section 50 increases away from the opening. Grip portions 55,56 are provided on either side of the pincer section 50 so that the pincer section 50 can be squeezed to urge the terminal regions 53,54 on either side of the opening 52 towards one another, while simultaneously allowing a downward motion to exert pressure on the elongate body 42 to flex outward. In response to the pressure from the simultaneous inward squeezing and downward force, terminal regions 53,54 of the pincer section 50 on either side of the opening expand past the outer surface 22 of cap 20, and allow the lips 42A of elongate body 42 to rest under the lower surface of cap 20 that covers bracket 2, as shown in FIG. 28B. When the simultaneous inward squeezing and downward force is released, the elongate body 42 returns to its natural state, thereby advancing cap 20 in hollow chamber 44, as shown in FIG. 28C. The tool 40 can then be moved to the next bracket 2 with a cap 20 to repeat the process again, with each new cap 20 residing in the hollow chamber 44 after removal and the lips 42A of elongate body 42 preventing the caps 20 from escaping hollow chamber 44, as shown in FIG. 28D.

According to another aspect of the disclosure, as shown in FIGS. 29A-29C, an alternative embodiment of cap 20 is illustrated in which a pair of inward concave dimples 128 may be formed in the middle portion of the cap 20 so as to be at least partially disposed within the space between the upper and lower bracket wings to prevent undesirable medial-distal movement of the engaged cap 20 relative to the bracket 2. Cap 20 comprises an elongate cap body having a length dimension extending along an axis 130 between first and second ends 20A-B of the cap body. The cap body has a width dimension with a substantially C-shaped cross sectional profile when viewed normal to the axis 130, as illustrated in FIG. 29A. The pair of opposed dimples 128 are symmetrically disposed relative to axis 130 and approximately midway between the first and second ends 20A-B of the cap body, the pair of opposed dimples 128 causing the width dimension of the cap body to be non-uniform between the first and second ends 20A-B thereof. In the illustrated embodiment, the side walls of inward concave dimple 128 are narrowed or tapered to mimic the space between the bracket wings as defined by bracket 2. When cap 20 is secured to bracket 2, as illustrated in FIGS. 30B, inward concave dimple 128 is at least partially disposed within the space between bracket wings 6, 8 thereby resisting inadvertent displacement in a mesial-distal direction and with the curved undersurface of cap 20 frictionally engaging with wings 6 and 8 of bracket 2.

The cap 20 illustrated in FIGS. 29A-C may be manufactured to have a monolithic structure using a single step or multiple step stamping process. For example, a rectangular piece of material may be stamped to form the cap body having a C-shaped cross-sectional profile, in either a single or multistep stamping process, followed by formation therein of the opposed dimples 128, again in either a single or multistep process, or vice versa, resulting in the monolithic article of manufacture illustrated in FIGS. 29A-C.

Any of the caps 20 illustrated and described herein may be formed from a variety of materials which may range from rigid to semi rigid to resilient while still allowing the cap to be frictional engaged with the brackets. Alternative embodiments of caps 20 may be manufactured from rigid materials, which may include, but are not limited too, stainless steel alloys and nickel-titanium alloys.

The disclosed orthodontic system provides a cosmetically attractive alternative to known orthodontic systems while greatly facilitating application and removal of the arch wire from the brackets, in a manner that overcomes the disadvantages of the prior art.

One skilled in the art will realize the disclosed system and components thereof may be embodied in other specific forms without departing from the spirit or essential characteristics thereof. The foregoing embodiments are to be considered in all respects illustrative rather than limiting of the concepts described herein. Scope of any invention concepts are thus indicated by the appended claims, rather than by the foregoing description, and all changes that come within the meaning and range of equivalency of the claims are therefore intended to be embraced therein.

What is claimed is:

1. A ligation cap article manufacture for use with a tooth mountable bracket having a pair of outwardly extending wings, the ligation cap article comprising:
an elongate cap body having a length dimension extending along an axis between first and second ends of the cap body, the cap body having a width dimension with a substantially C-shaped cross sectional profile when viewed normal to the axis; and
a pair of opposed dimples disposed in the cap body between the first and second ends of the cap body, the pair of opposed dimples causing the width dimension of the cap body to be non-uniform between the first and second ends thereof.

2. The article claim 1 wherein the pair of opposed dimples are disposed midway between the first and second ends of the cap body.

3. The article claim 1 wherein the pair of opposed dimples are symmetrically disposed relative to the axis.

4. The article claim 1 wherein the cap body frictionally engages the pair of outwardly extending wings of the bracket.

5. The article claim 2 wherein the width dimension of the cap body varies along the axis between the ends and the pair of opposed dimples.

6. The article claim 1 wherein the cap body has a monolithic structure.

7. A ligation cap apparatus for use with a tooth mountable bracket, the bracket defining a wire slot into which an arch wire may be at least partially retained, the ligation cap comprising:
a cap body defining an first surface disposable adjacent the bracket;
a support ridge extending outwardly from the first surface and at least partially disposable within the wire slot of the bracket; and
a retention feature extending outwardly from the first surface and engageable with bracket.

8. The apparatus of claim 7 wherein the support ridge has a length dimension which at least substantially equals or exceeds a length dimension of the wire slot.

9. The apparatus of claim 1 wherein the wire slot is at least partially defined by nonparallel surfaces of the bracket and wherein the support ridge is at least partially defined by nonparallel surfaces.

10. The apparatus of claim 7 wherein the cap body defines a second surface opposite the first surface, the second surface having a visually discernible characteristic.

11. An orthodontic system for use with a plurality of tooth mountable brackets, each bracket defining a wire slot into which an arch wire may be at least partially retained comprising:
a plurality of ligation caps, each ligation cap being adapted to be received on a respective bracket in a snap fit manner for retaining the arch wire within the arch wire slot of the respective bracket, and
a removal tool comprising at least one actuating part arranged to be engaged between a respective bracket and the cap attached thereto to remove the cap from the bracket.

12. A system as claimed in claim 11, wherein each ligation cap is formed from a resilient material defining an smooth outer face.

13. A system as claimed in claim 12, wherein the outer face of at least one ligation cap displays a visually discernible graphic element.

14. A system as claim 11 further comprising a plurality of brackets each comprising a base having a lower surface adapted to be mounted on an individual tooth, said arch wire slot being defined between at least one pair of outwardly and oppositely extending wings extending from the base of the bracket, wherein each of said ligation caps is adapted to be a snap fit over the at least one pair of wings of a respective bracket.

15. A removal tool for removing a ligation cap from an orthodontic bracket, said removal tool comprising at least one actuating part arranged to be engaged between a respective bracket and the cap attached thereto to remove the cap from the bracket.

16. A removal tool as claimed in claim 15, wherein said at least one actuating part of the removal tool comprises at least one tapered projection arranged to be inserted between the base of the respective bracket and a lower edge of the ligation cap attached thereto, said tapered projection being arranged to be urged into the gap between the base of the bracket and the lower edge of the cap such that the increasing thickness of the tapered projection away from a distal end thereof acts to push the cap off the bracket or wherein said at least one actuating part of the removal tool comprise a first part arranged to engage the base of the respective bracket and a second part arranged to engage a lower edge of the cap attached thereto, said first and second parts being arranged to be displaced away from one another, acting between the base of the bracket and said lower edge of the cap to force the cap upwardly with respect to the bracket, removing the cap from the bracket.

17. A removal tool as claimed in claim 15, wherein said at least one actuating part of the removal tool may comprise a first part arranged to engage the base of the respective bracket and a second part arranged to engage a lower edge of the cap attached thereto, said first and second parts being arranged to be displaced away from one another, acting between the base of the bracket and said lower edge of the cap to force the cap upwardly with respect to the bracket, removing the cap from the bracket.

18. A removal tool as claimed in claim 17, wherein said actuating parts comprise opposing parts arranged to be located adjacent opposite sides of a respective bracket, each of said opposing parts comprising a first part arranged to engage the base of the respective bracket and a second part arranged to engage a lower edge of the cap attached thereto on a respective side of the cap.

19. A removal tool as claimed in claim 15 wherein the removal tool is arranged to retain the ligation caps once removed from the brackets.

20. A removal tool as claimed in claim 19, comprising a hollow body having a chamber for receiving said caps, an opening being provided at a lower end of said chamber adjacent said at least one actuating part, wherein the caps are arranged to enter the chamber via said opening when removed from the respective bracket by the action of the at least one actuating part.

21. A removal tool as claimed in claim 20, wherein at least one gate or flap is associated with said opening for retaining the caps within the chamber, said at least one gate or flap being arranged to be deflected inwardly to permit passage of a cap into the chamber.

22. A removal tool as claimed in claim 21, wherein the gate or flap is replaceable for hygiene reasons and/or to facilitate removal of the caps from the chamber.

23. The system of claim 11 further comprising a common carrier upon which said ligation caps are disposed to facilitate installation of the ligation caps upon the brackets once the brackets have been mounted on individual teeth.

24. An orthodontic system as claimed in claim 23, wherein the ligation caps are arranged on the common carrier in accordance with physical positioning of the teeth within the mouth.
